(19) United States
(12) Patent Application Publication
(10) Pub. No.: US 2006/0159339 A1
(43) Pub. Date: Jul. 20, 2006

(54) Method and apparatus as pertains to captured image statistics

(75) Inventors: Sek M. Chai, Streamwood, IL (US); Mohamed Ahmed, Glendale Heights, IL (US); Nikos Bellas, Chicago, IL (US); Gregory A. Kujawa, St. Charles, IL (US); King F. Lee, Schaumburg, IL (US); Abelardo Lopez Lagunas, Colonia Univeridad (MX)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 11/038,904

(22) Filed: Jan. 20, 2005

(51) Int. Cl. G06K 9/00; G06K 9/46

(52) U.S. Cl. 382/168; 382/190

(57) ABSTRACT

Captured images are provided (101) and analyzed (102) to generate corresponding image content information. One or more statistics are then generated (103) as a function of that image content information and those statistics transmitted (104) to a remote receiver via a communication link (or links) of choice. That statistical information, alone or in combination with similar information from other sources, can then be processed (302) to facilitate developing information regarding preferences, experiences, and/or the like regarding the user (or users) of a given device.

### TECHNICAL FIELD

This invention relates generally to the analysis and processing of captured images.

### BACKGROUND

Automated image analysis is known in the art. Such analysis includes, in particular, the recognition of image content in a captured image. As but one illustrative example, this could comprise analyzing a captured image to recognize that the captured image contains a given model of automobile.

The ability to capture an image is also becoming simpler and more common. In addition to an increasing proliferation of digital cameras, many other devices are being provided with image capture functionality. For example, cellular telephones, personal digital assistants, and even automobiles are all being provided with integral image capture capability. As a result, an ever-growing number of people are engaging in their ordinary and usual daily activities and/or their special events in the company of one or more devices that has image capture capability.

In general, such image capture capability typically serves only the needs of an immediate user and/or platform. For example, a given individual may capture images that they wish to retain as a personal record of their own activities or a collision avoidance system on a vehicle may capture images solely to provide relevant data regarding the present surroundings of the vehicle in order to assess a present likelihood of colliding with an object. For the most part, few suggestions have been offered regarding other possible uses and applications of such data.

### BRIEF DESCRIPTION OF THE DRAWINGS

The above needs are at least partially met through provision of the method and apparatus as pertains to captured image statistics described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a device provides a captured image and analyzes that captured image to generate information regarding image content in the captured image. That device then generates at least one statistic as a function, at least in part, of this information regarding the image content and then transmits information regarding this at least one statistic to a remote receiver.

Such statistics can serve to represent any of a wide variety of user preferences or activities such as location preferences, activity preferences, behavior preferences, and so forth. These statistics can correspond to a single user of a given device and/or can correspond to a larger demographic group of interest. Depending upon the embodiment, these statistics can then drive and/or otherwise inform a variety of uses and/or applications. For example, such statistics can serve to influence the provision of instructions to the image capture device regarding the capture and/or processing of subsequent images. As another (perhaps more significant) example, such statistics can serve to influence, at least in part, a subsequent action by an advertiser.

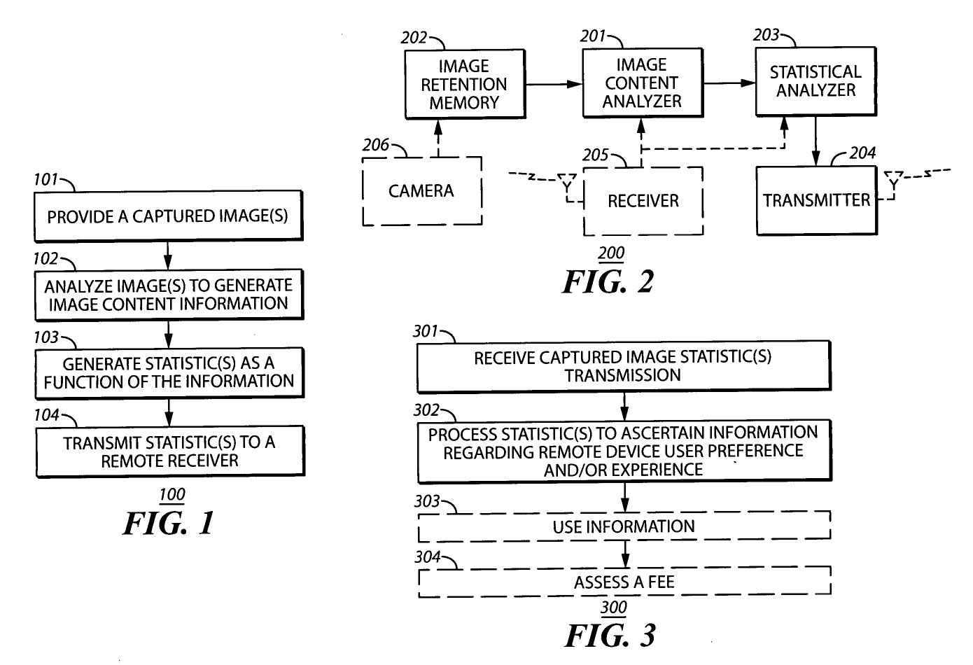

These and other benefits may become clearer upon making a thorough review and study of the following detailed description. Referring now to the drawings, and in particular to FIG. 1, a generalized process 100 as comports with these teachings typically comprises provision 101 of a captured image and analyzing 102 that captured image to generate information regarding image content in the captured image. Provision 101 of the captured image can be effected using any of a wide variety of presently known or hereafter-developed techniques and/or devices. Generally speaking, this includes, but is not limited to, automatically capturing the captured image in response to receiving a corresponding command from a remote source and/or in response to detection of a device user's instruction (via, for example, assertion of a camera shutter switch) to capture the image.

This process 100 also encompasses provision 101 of a plurality of captured images. Such a plurality can comprise temporally related images (as characterizes, for example, a video comprised of a series of captured image frames), a set of temporally unrelated images, and so forth.

Generally speaking, in a preferred approach, these captured images comprise digital representations. These teachings are generally compatible with essentially any image capture techniques and/or rendering methodologies, including but certainly not limited to TIF, JPEG, the MPEG image encoding family, and standard bit-mapping image encoding techniques, to name but a few. These teachings are also compatible for use with monochromatic images, full color images, and special images such as may be attained using infrared imaging, radar imaging, ultrasonic imaging, magnetic resonance imaging, and the like.

The field of image capturing constitutes a wide, deep, and well-understood area of endeavor. Furthermore, these present teachings are not particularly sensitive to selection of any particular image capture technique or apparatus. Therefore, for the sake of brevity and the preservation of narrative focus, further elaboration regarding such techniques will not be provided here.

The image analysis 102 activity will typically comprise using at least one corresponding process to at least attempt to effect recognition of at least some image content of the captured image. This may comprise, in some circumstances, recognition of general geometric shapes (such as circles) or, more typically, will comprise recognition of more specific objects (such as vehicles, restaurant interiors, people, tourist attractions, buildings, and so forth, to name but a few). For some purposes it may be adequate to have but a single image recognition process available for this purpose. More typically, however, it will probably be useful to have a plurality of candidate processes available. The enabling platform itself can select from amongst these candidate processes and/or can be responsive to, for example, an instruction from a remote source that identifies the process (or processes) to use (either exclusively or via some prioritized scheme of incremental and/or sequential usage). In a preferred approach this process forms an adaptive process in which the request and selection of a particular process (or processes) can be tuned to improve the recognition of at least some image content of the captured image.

Depending upon the needs and/or limitations of a given application, the enabling apparatus may have a wholly self-contained process (or processes) available to effect such analysis or may, in a more preferred approach, have the capacity to receive at least a portion of one or more such processes via a transmission from a remote source. The latter approach may better facilitate the use of relatively inexpensive enabling platforms (such as camera-equipped cellular telephones) that will typically have a smaller available memory capacity than a comparable non-portable device. This approach also permits a given enabling platform to remain relatively up-to-date with respect to particular objects to be recognized as new processes corresponding to new objects to be recognized can be readily provided.

As noted above, a plurality of captured images may be provided 101. In such a case, it may be useful to use some or all of that plurality of captured images to effect the analysis step 102. For example, when a plurality of captured images portray a given object from various angles and/or portray that object in some context with respect to its environment, those images may be providing additional clues regarding the identity of the object that can be accordingly leveraged for purposes of recognizing that object.

The specifics of the nature of the analysis itself can vary with the needs of a given setting and application. Some illustrative examples include, but are surely not limited to, analyzing images to obtain physical characteristics regarding people (for example, gender, height, weight, race, age, and so forth), locations (for example, indoor settings, outdoor settings, and so forth), and activities (for example, sporting activities, leisure activities, business activities, shopping activities, culinary activities, and so forth).

This process 100 then generates 103 at least one statistic as a function, at least in part, of the information regarding the image content. As with the image analysis process, this step 103 can comprise using a statistical analysis process as is selected from amongst a plurality of available candidate statistical analysis processes or, if desired, can comprise the only statistical analysis process as may be available to a given processing platform at a given moment in time. Also as with the image analysis process, the statistical analysis process can be locally sourced or can be sourced, in whole or in part, from a remote location as may best comport with the needs of a specific implementation.

The generated statistic (or statistics) serves to preferably represent a user preference, experience, and/or record or activity of interest. A non-exhaustive listing might comprise:
a location preference;
an activity preference;
a behavior preference;
a viewing preference;
an entertainment preference;
a dining preference;
a consumer preference;
a temporal preference;
an incident record;
an encounter or experience record; and/or
physical characteristics (such as, but not limited to, age, gender, and so forth) regarding people;
to name but a few. Such statistics can be generated to correspond to a single user of a given device (such as a camera-capable cellular telephone), to at least one demographic group of interest (such as an age group or gender of interest), and so forth. In other embodiments, such statistics can be used to define or generate demographic groups.

This process 100 provides for transmission 104 of this at least one statistic to a remote receiver (such as a server configured to receive and further process or consider such statistical input). This transmission can comprise a wireless transmission and/or a wired transmission as may best reflect and/or suit the needs and/or requirements or capabilities of a given implementation. Such transmissions can be automated and triggered by some appropriate input of choice (such as the present availability of one or more such statistics, a statistic exceeding some predetermined threshold, or the like) or can be initiated in response, for example, to a specific instruction of the user of the implementing platform. Other possibilities exist as well. For example, this transmission may be in response to receipt of a message from a remote location instructing that the transmission occur.

So configured, a device (such as a user-carried device such as a camera-equipped cellular telephone) can review captured images (including images captured at the instance of a device user and/or autonomously captured images) for content and then develop statistics of interest as a function of the content of those images. As a very simple illustrative example, these teachings can be employed to determine, for example, how many vehicles of a particular class or model a given user encounters over some temporal window of interest (such as over a 24 hour period, a week, a month, or the like). As another very simple illustrative example, these teachings can serve to develop statistics regarding which portions of a given tourist attraction are of particular interest to a demographic group of interest (such as, for example, females of 21 to 29 years of age).

These teachings can be readily implemented, in whole or in part, by a wide variety of enabling platforms. Pursuant to a preferred approach, and referring now to FIG. 2, a given device 200 will comprise an image content analyzer 201 having an input operably coupled to an image retention memory 202 and having a recognized image object output. In an optional but preferred approach, the device 200 also integrally comprises an image capture device such as a camera 206 that captures the images to be analyzed and stores them in the image retention memory 202. The image content analyzer 201 preferably serves to use at least one image analysis process to attempt to effect recognition of at least some portion of an image that is contained in the image retention memory 202.

This device 200 further preferably comprises a statistical analyzer 203 that operably couples to the recognized image object output and that issues a corresponding statistical representation output. In this embodiment the latter output in turn couples to a transmitter 204 to thereby permit transmission of the statistical information generated by the statistical analyzer 203.

In an optional embodiment this device 200 can further comprise a receiver 205. This receiver 205 can operably couple to the image content analyzer 201 and/or the statistical analyzer 203. So configured, the receiver 205 can receive image content analysis processes and/or statistical analysis processes for use by the image content analyzer 201/statistical analyzer 203, respectively. Or, if desired, the receiver 205 can facilitate receiving remotely sourced instructions regarding which process of a plurality of available processes to use when operating the image content analyzer 201 and/or the statistical analyzer 203 as described above.

The above-described components can comprise physically separate discrete elements if desired. More typically, however, two or more of these elements can be wholly or partially combined in a shared facilitating platform. For example, many cellular telephones include a programmable processing platform such as a microprocessor. Such a microprocessor can be readily programmed in accordance with these teachings. In such a case, such a microprocessor might serve to facilitate at least a part of both the image content analyzer 201 and the statistical analyzer 203.

As specified above, captured images can be analyzed for content and statistics formed as a function, at least in part, of the recognized aspects of that content. Such statistical information is then transmitted to a remote receiver. (As used herein, “remote” refers to physically and geographically separated locations.) Referring now to FIG. 3, a corresponding illustrative remote receiver process 300 can comprise receiving 301 such a transmission (or transmissions) as comprises at least one statistic representing at least some aspect of at least one captured image and then processing 302 this statistical information to thereby ascertain information regarding a characteristic of interest (such as, but not limited to, at least one preference as corresponds to at least one user of the remote device (and/or a demographic group as includes that user or users) that sourced the statistic, at least one experience of that user, or such other representation as may be desired).

This processing can comprise any information manipulation as may serve a desired purpose. For example, this processing can comprise the aggregation of statistics from multiple remote sources and/or the development of averages, means, and so forth as corresponds to such statistics.

Preferably, though optionally, this information is then used 303 in support of some desired purpose. For example, such information could be used to influence, at least in part, an instruction to transmit to the remote device regarding processing by that remote device of subsequent images. To illustrate, such instructions might comprise one or more of:
capturing, analyzing, and statistically processing images with increased or decreased automated periodicity;
only forwarding statistical information as corresponds to a particular identified object or category/genre of objects;
observing (or ignoring) a particular schedule when transmitting statistical information;
receiving, installing, and subsequently using a new and/or supplemental image recognition and/or statistical analysis process;
switching to an autonomous image capture mode of operation; and so forth, to name but a few.

Such information could be used in other ways as well. As another example, such information could be used to influence, at least in part, a subsequent action by an advertiser. As one illustration, a given advertiser might effect the provision and/or alteration of a specific advertising message at one or more specific geographic locations and/or via one or more mediums of conveyance based upon the statistical information generated via these teachings. Such actions may be intended simply to better reach and serve the needs and interests of a given remote device user or may be intended to better relate to, for example, a corresponding demographic group.

As yet another example, such statistics could be used to influence and/or drive the generation or alteration of characteristics that identify demographic groups of interest. In particular, this combination of remote image capture, content recognition, and generation of corresponding statistics regarding such content can be correlated to other elements such as the remote device user (or users), specific locations, specific content, and so forth. More particularly, correlations can be drawn from such an information mixture to permit and facilitate the identification of previously unrecognized demographic groups. This, in turn, can be leveraged in various ways to benefit, for example, advertisers, users, and the like.

These examples are intended to be both illustrative and non-exhaustive with numerous other possibilities being available as will be understood and appreciated by those skilled in the art.

Those skilled in the art will further appreciate that such information has considerable potential value to various parties. Accordingly, this process 300 may also optionally comprise the assessment 304 of one or more fees as correspond to one or more steps and/or results of these teachings. A non-exhaustive listing of illustrative examples would include assessing such a fee to be paid as a function, at least in part, of:
ascertaining (i.e, recognizing) the content of a given captured image;
processing (including but not limited to generating or using) the statistic(s);
receiving the transmission(s) that comprises such statistical information;
processing a process as is used to facilitate the processing of the at least one statistic; and so forth, to name but a few. Such fees could be paid to any appropriate party or parties, including but not limited to a remote statistics gatherer, the device user, and so forth.

Furthermore, such statistics can be archived (in the user apparatus, in a remote receiver, and/or elsewhere as appropriate) for later use or processing as a means to derive new statistics and generation of information. Those skilled in the art will appreciate that fees can be obtained from handling such statistics in their unprocessed or archived state.

So configured, images as captured by a wide variety of devices (such as, but not limited to, smart cameras) are analyzed for content and statistics derived regarding that content using embedded machine vision and statistical analysis algorithms. Those statistics are then conveyed to a remote site (or sites) for leveraged consideration. These teachings are compatible for application in a wide variety of settings including personal use applications, autonomous use applications, demographic group studies, and so forth. Those skilled in the art will appreciate that data comprising statistics will typically comprise a considerably smaller payload than a captured image itself. The conveyance of such statistics, therefore, will typically provide little burden to existing communications infrastructure including most wireless networks.

User preferences can be readily determined via this approach, including contextual user-information reflecting single users (for example, individual user preferences, favored locations, favored dining experiences, favored activities, and so forth) as well as groups (defined, for example, via one or more demographic characteristics). Beneficially, as these teachings are employable with mobile platforms such as camera-equipped two-way communication devices, the context can vary with such mobility and thereby provide a richer single-user context-aware point of view. The resultant information can be leveraged in various ways including, but not limited to, by improving the effectiveness of targeted-advertising, marketing strategies, or even product development. Those skilled in the art will appreciate that such information will comprise, in many instances, unique information reflecting insights not readily available through other viable means.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one illustration of this point, part or all of a given captured image (or images) may be conveyed when transmitting the statistical information. Such image information may, in turn, be used to assist with the study and/or usage of the statistics themselves.

We claim:

1. A method for use with a device comprising:
providing a captured image;
analyzing the captured image to generate information regarding image content in the captured image;
generating at least one statistic as a function, at least in part, of the information regarding the image content;
transmitting the at least one statistic to a remote receiver.

2. The method of claim 1 wherein:
providing a captured image further comprises providing a plurality of captured images;
analyzing the captured image further comprises analyzing a plurality of the plurality of captured images to generate information regarding image content of the plurality of the plurality of captured images;
generating at least one statistic further comprises generating a plurality of statistics as a function, at least in part, of the information regarding the image content of the plurality of the plurality of captured images;
transmitting the at least one statistic further comprises transmitting at least one:
at least one of the plurality of statistics;
a consolidated statistic that represents more than one of the plurality of statistics.

3. The method of claim 1 wherein providing a captured image further comprises automatically capturing the captured image.

4. The method of claim 3 wherein automatically capturing the captured image further comprises at least one of:
automatically capturing the captured image in response to receiving a corresponding command from a remote source;
capturing the captured image in response to detection of a device user's instruction to capture an image.

5. The method of claim 1 wherein analyzing the captured image to generate information regarding image content in the captured image further comprises utilizing at least one process to attempt to effect recognition of at least some image content of the captured image.

6. The method of claim I wherein generating at least one statistic as a function, at least in part, of the information regarding the image content further comprises using a statistical analysis process as is selected from amongst a plurality of available candidate statistical analysis processes.

7. The method of claim 6 wherein generating at least one statistic as a function, at least in part, of the information regarding the image content further comprises receiving at least a portion of at least one statistical analysis process in a transmission from a remote source.

8. The method of claim 6 wherein generating at least one statistic as a function, at least in part, of the information regarding the image content further comprises utilizing a plurality of statistical analysis processes to attempt to generate at least one statistic.

9. The method of claim 6 using a statistical analysis process as is selected from amongst a plurality of available candidate statistical analysis processes further comprises selecting the statistical analysis process from amongst the plurality of available candidate statistical analysis processes.

10. The method of claim 9 wherein selecting the at least one process from amongst a plurality of available candidate processes further comprises receiving a transmission comprising an instruction from a remote source that identifies the at least one process.

11. The method of claim 1 wherein generating at least one statistic further comprises generating the at least one statistic to represent at least one of:
a location preference;
an activity preference;
a behavior preference;
a viewing preference;
an entertainment preference;
a dining preference;
a consumer preference;
a temporal preference;
an incident record;
an encounter record;
physical characteristics regarding people.

12. The method of claim 1 wherein generating at least one statistic further comprises generating at least one statistic as corresponds to a single user of the device.

13. The method of claim 1 wherein generating at least one statistic further comprises generating at least one statistic as corresponds to at least one demographic group.

14. An apparatus comprising:
an image retention memory;
at least one image content analyzer operably coupled to the image retention memory and having a recognized image object output;
a statistical analyzer operably coupled to the recognized image object output and having a corresponding statistical representation output;
a transmitter operably coupled to the statistical representation output.

15. The apparatus of claim 14 wherein the apparatus comprises a communications device having an integral camera.

16. The apparatus of claim 14 wherein the at least one image content analyzer further comprises analysis means for using at least one image analysis process to attempt to effect recognition of at least some portion of an image that is contained in the image retention memory.

17. A method comprising:
receiving a transmission comprising at least one statistic, which statistic represents at least some aspect of at least one image as was captured by a remote device;
processing the at least one statistic to thereby ascertain information regarding at least one of a preference and an experience as corresponds to at least one user of the remote device.

18. The method of claim 17 and further comprising using the information to influence, at least in part, an instruction to transmit to the remote device regarding remote device processing of subsequent images.

19. The method of claim 17 and further comprising using the information to influence, at least in part, a subsequent action by an advertiser.

20. The method of claim 17 and further comprising assessing a fee to be paid as a function, at least in part, of at least one of:
ascertaining the information;
processing the at least one statistic;
receiving the transmission comprising at least one statistic;
processing a process as is used to facilitate the processing of the at least one statistic.
